(19) United States
(12) Patent Application Publication
(10) Pub. No.: US 2026/0151982 A1
(43) Pub. Date: Jun. 4, 2026

(54) Collar for compressing sleeve on drum

(71) Applicant: Suominen Oyj, Espoo (FI)

(72) Inventor: Joni Naski, Espoo (FI)

(21) Appl. No.: 19/118,800

(22) PCT Filed: Oct. 4, 2023
(86) PCT No.: PCT/FI2023/050568

§ 371 Date: Apr. 7, 2025

(30) Foreign Application Priority Data
Oct. 5, 2022 (FI) 20225898

(51) Int. Cl. E21B 33/129; G03G 15/00; H02G 3/22

(52) U.S. Cl. CPC B31F 1/07

(57) ABSTRACT

According to an example aspect of the present invention, there is provided a collar (100) for compressing a sleeve on a drum (200), the collar (100) comprising: an inner part (110) configured to be attached to an end of the drum (200), an outer part (130), and a slip part (120) between the inner part (110) and the outer part (130), which slip part (120) is configured to be engaged with the sleeve, wherein the inner part (110), the slip part (120) and the outer part (130) are assembled together in succession along an assembly axis, and the slip part (120) is configured to translate between the inner part (110) and the outer part (130) along the assembly axis.

### FIELD

The present invention relates to a collar for a drum for compressing a sleeve on the drum, which drum is used in forming, pressing or moulding a fibrous web, as well as to a method for installing such collar on a drum, a drum comprising the collar and a nonwoven web machine comprising the collar.

### BACKGROUND

The surface structure of various webs, e.g. tissue paper and nonwoven fabrics, may be modified during production to obtain a pattern of raised or compressed portions. The obtained pattern may also include apertures in the web. Patterning can be done both for aesthetic reasons and in order to provide desired technical characteristics in the product. The process of imposing patterns on a web is often referred to as embossing.

The pattern may be imposed by a drum having a replaceable embossing sleeve. The sleeve has a form of an open-ended cylinder with two edges. The sleeve is configured to be arranged on the drum, concentrically with it. This means that the rotational axis of the sleeve is identical to the rotational axis of the drum. When installing the sleeve on the drum, it should be usually ensured that the sleeve stays on its place. The sleeve should fit tightly on the drum, such that the sleeve rotates together with the drum and has minimal phase difference with it. Presently, the sleeve is usually attached on the drum by an air-filled collar. The collar is placed at the end of the drum and inside the sleeve so that the collar is pressed against the end of the sleeve from the inside of the sleeve.

An aim of the present invention is thus to provide a collar which creates even pressure along the entire circumference of the sleeve to keep it on its place and straight. The sleeve can be made of metal or plastic. When the sleeve is made of a plastic, it can swell or shrink due to variation of humidity and temperature. A further aim of the present invention is thus to provide a collar which is able to compensate the deformation of the sleeve due to the swelling or shrinking, i.e. the collar should allow for some movement of the parts due to dimensional changes.

### SUMMARY OF THE INVENTION

According to a first aspect of the present invention, there is provided a collar for compressing a sleeve on a drum, the collar comprising an inner part configured to be attached to an end of the drum, an outer part, and a slip part between the inner part and the outer part, which slip part is configured to be engaged with the sleeve, wherein the inner part, the slip part and the outer part are assembled together in succession along an assembly axis, and the slip part is configured to translate between the inner part and the outer part along the assembly axis.

According to a second aspect of the present invention, there is provided a drum for use in forming, pressing or moulding a fibrous web comprising the collar.

According to a third aspect of the present invention, there is provided a nonwoven web machine comprising the collar.

According to a fourth aspect of the present invention, there is provided a method for installing a sleeve on a drum comprising: providing the sleeve on the drum, and attaching the collar to an end of the drum for creating even pressure along the entire circumference of the sleeve.

### BRIEF DESCRIPTION OF THE DRAWINGS

FIG. 1 illustrates a collar in accordance with at least some embodiments of the present invention;

FIG. 2A illustrates an inner surface of an inner part in accordance with at least some embodiments of the present invention;

FIG. 2B illustrates an outer surface of an inner part in accordance with at least some embodiments of the present invention;

FIG. 3 illustrates a slip part in accordance with at least some embodiments of the present invention;

FIG. 4A illustrates an inner surface of an outer part in accordance with at least some embodiments of the present invention;

FIG. 4B illustrates an outer surface of an outer part in accordance with at least some embodiments of the present invention;

FIG. 5 illustrates a biasing mechanism in accordance with at least some embodiments of the present invention;

FIG. 6 illustrates a pivot in accordance with at least some embodiments of the present invention;

FIG. 7 illustrates a groove on an outer perimeter of the collar and a wedge configured in the groove in accordance with at least some embodiments of the present invention; and

FIG. 8 illustrates a wedge configured to be placed in the groove in accordance with at least some embodiments of the present invention.

### EMBODIMENTS

In the present context, the term “an inner surface of an inner part” refers to a surface of the inner part, which is facing an outer part, when parts of a collar are assembled together.

In the present context, the term “an outer surface of an inner part” refers to a surface of the inner part, which is on opposite side of the inner part than the inner surface.

In the present context, the term “an inner surface of an outer part” refers to a surface of an outer part, which is facing the inner part, when parts of the collar are assembled together.

In the present context, the term “an outer surface of an outer part” refers to a surface of the outer part, which is on opposite side of the outer part than the inner surface.

In the present context, the term “an outer perimeter” refers to an area on an outer edge of a collar or its part, for example, an inner part or an outer part.

According to an embodiment, a collar 100 for compressing a sleeve on a drum 200 comprises an inner part 110 configured to be attached to an end of the drum 200, an outer part 130, and a slip part 120 between the inner part 110 and the outer part 130. The slip part 120 is configured to be engaged with the sleeve. The inner part 110, the slip part 120 and the outer part 130 are assembled together in a succession along an assembly axis. The slip part 120 is configured to translate between the inner part 110 and the outer part 130 along the assembly axis.

The slip part is configured to translate between the inner part and the outer part along the assembly axis during operation of the drum. The collar provides an even pressure along the entire circumference of the sleeve by the slip part, thus keeping the sleeve on its place and straight. By “even pressure” is meant that the pressure is in the range of +/−10%, preferably +/−5%, more preferably +/−2%, along the entire circumference of the sleeve. In the case of the sleeve having at least two parts, the line speeds of nonwoven machines and hence the rotation speeds of drums are such that if a sleeve were made of parts, the parts would rotate at different speeds, leading to mistakes in the patterning as well as probable problems of distortion of the parts. Such deformation or distortion could then easily lead to breakage of the parts, leading to production losses and additional costs. The collar ensures that the parts stay aligned with each other. Further, the collar provides an even pressure to the parts in the ends and in the middle of the sleeve. The collar is able to compensate the deformation of the sleeve, by the translation of the slip part between the inner part and the outer part. So, the slip part moves between the inner part and the outer part as a result of an increase or decrease in the force caused by the deformation of the sleeve on the slip part in a longitudinal direction of the drum. Thus, there is no need manually to adjust the pressure along the circumference of the sleeve during the operation of the drum, but the pressure is adjusted automatically by the translation of the slip part. Thus, the collar can prevent the sleeve from breakage. So, production losses, additional costs and excess machine downtime can be avoided.

The sleeve can be a one-piece sleeve or it can comprise at least two parts. The at least two parts can have peripheral locking forms adapted to lock the parts to each other. The locking forms of the parts can be identical or different, provided that the locking forms of adjacent edges of adjacent parts fit one another for locking the parts to each other. The peripheral locking forms can be selected from a group consisting of sinusoidal forms, zigzag-forms and wave forms. Therefore, corresponding forms can be identical (such as a regular zigzag-form), or they may be mirror images (for example wave forms with varying wave lengths). Alternatively, one peripheral locking form can be a female form and the adjacent peripheral locking form can be a corresponding male form. The forms may be any suitable forms, such as a rounded or rectangular slot and the corresponding projection. Alternatively, a first part can comprise a first lip part towards the inner volume of the part, i.e. its outer surface is even while its inner surface is thinner the rest of the part. A second part can comprise a corresponding lip part, which is flush with the inner surface of the sleeve part, and arranged to fit within the first lip part. Optionally, the first lip part can comprise recesses and the corresponding lip part can comprise protrusions.

According to an embodiment, the slip part 120 is configured to translate 20-40 mm, preferably 25-35 mm, between the inner part 110 and the outer part 130. Thus, the collar is able to compensate the deformation of the sleeve even in a case wherein an amount of deformation is high, for example, in a case of a substantially long sleeve and severe moisture and/or temperature changes.

According to an embodiment, the slip part 120 comprises a flange 121 extending perpendicularly to the assembly axis. The flange comprises a first surface and an opposite second surface. The first surface faces the sleeve and is configured to engage the sleeve on the drum. The flange provides reliable attachment of the sleeve on the drum. The flange secures that the sleeve cannot protrude over the collar, but stays firmly attached on the drum.

According to an embodiment, the slip part 120 comprises several mounting attachments 122 protruding towards a centre of the slip part 120 perpendicularly to the assembly axis. The mounting attachments 122 can be arranged at regular intervals at the slip part. The slip part 120 can comprise for example, four, six, eight or ten mounting attachments 122. The mounting attachments enable assembling the slip part with the inner part and the outer part along the assembly axis.

The inner part 110 and the outer part 130 can comprise several mounting recesses 113, 133 for receiving the mounting attachments 122 of the slip part 120. A number of the mounting recesses 113, 133 can be, and preferably is, equal to the number of the mounting attachments 122. The inner part 110 and the outer part 130 can comprise for example, four, six, eight or ten mounting recesses 113, 133. A shape of the mounting recesses 113, 133 preferably corresponds the shape of the mounting attachments 122. The mounting recesses 113 can be formed on an inner surface of the inner part 110 and an inner surface of the outer part 113. The mounting recesses 113 of the inner part 110 form with the mounting recesses 133 of the outer part a sledge where the mounting attachments 122 can translate between the inner part 110 and the outer part 130 in the direction of the assembly axis.

According to an embodiment, the collar 100 further comprises several biasing mechanisms 140 arranged inside the collar 100, extending between the slip part 120 and the outer part 130 in a direction of the assembly axis. The biasing mechanisms are able to conform and assist in the translation of the slip part.

The several biasing mechanisms 140 can be arranged at regular intervals in the collar 100. Preferably, the biasing mechanisms are arranged in pairs, so that one biasing mechanism is placed on the opposite side of the circumference of the collar than the other biasing mechanism of the pair. Thus, the biasing mechanism assists in providing an even pressure along the entire circumference of the sleeve.

The collar 100 can comprise four to ten biasing mechanisms 140, such as four, six, eight or ten biasing mechanisms 140. Thus, the collar comprises enough of the biasing mechanisms to provide an even pressure along the entire circumference of the sleeve.

According to an embodiment, the several biasing mechanisms 140 are configured to extend through the several mounting attachments 122. Thus, biasing mechanisms are connected to the slip part and are thus able to conform and assist in the translation of the slip part.

According to another embodiment, the several biasing mechanisms 140 comprise coil springs 142 or leaf springs. So, the coil springs or leaf spring extend between the inner part and the outer part inside the collar substantially in a direction of the assembly axis. The coil springs or leaf springs are configured to shorten or extend as a result of an increase or decrease in the force on the slip part in the direction of the assembly axis.

A spring force of the coil spring 142 can be 200 to 400 Nm, preferably 250 to 350 Nm.

A length of the coil spring 142 can be configured to shorten or extend 10 to 20 mm, preferably 12 to 17 mm, from an initial length of the coil spring 142. Thus, the collar is able to compensate deformation of the sleeve with an aid of the coil springs even in a case where an amount of the deformation is high, for example, in a case of a substantially long sleeve and severe moisture and/or temperature changes.

According to an embodiment, a pivot 141 is configured to extend through the coil spring 142 in a longitudinal direction of the coil spring 142. The pivots 141 can extend from an outer surface of the outer part 130 to inside of the inner part 110. Heads 141a of the pivots 141 can be arranged inside the outer part 130 so that a surface of the head 141a is substantially at the same level than the outer surface of the outer part 130. The pivot secures that the coil spring stays straight.

An outer surface of the outer part 130 can comprise several pivot recesses 131 for receiving the heads 141a of pivots 141.

The end 141b of the pivot 141 can comprise a recess 141c for receiving a fastening means, such as screws. The fastening means can extends from the inner part 110 to inside of the recess 141c for attaching the end of the pivot 141b to the inner part 110. A head of the screw 143 can be substantially at the same level than the outer surface of the inner part 110.

The inner part 110 can comprise several fastening apertures 111 for receiving a pivot 141 and for attaching the inner part 110 to an end 141b of the pivot 141. In other words, the fastening apertures 111 are for securing the pivot and binding parts of the collar, i.e. the inner part, the slip part and the outer part, together. A number of the fastening apertures 111 can be, and preferably is, equal than a number of the pivots 141. The inner part 110 can comprise for example four, six, eight or ten fastening apertures 111. The fastening apertures 111 can be configured at regular intervals at the inner part 110.

According to an embodiment, the collar further comprises a plurality of pins (not illustrated) extending from the inner part 110 to the outer part 130 to centre the inner part 110 and the outer part 130 relative to each other. Thanks to the pins, it is easier to centre the inner part and the outer part relative to each other during an assembly stage of the collar.

The inner part 110 and the outer part 130 can comprise attachment apertures 112, 132 for attaching the collar 100 to an end of the drum 200. The collar 100 can be attached to the end of the drum 200 by fastening means, such as bolts, via the attachment apertures 112, 132. The fastening means extend from the outer part 130 to the inner part 110 via the attachment apertures 112, 132. The inner part 110 and the outer part 130 can, and preferably does, comprise an equal amount of the attachment apertures 112, 132. The inner part 110 and the outer part 130 can comprise for example, four, six, eight or ten attachment apertures 112, 132. The attachment apertures 112, 132 can and preferably are arranged at regular intervals to the inner part 110 and the outer part 130.

Alternatively, the outer part 130 can comprise several protrusions and the inner part 110 can comprise respective recesses for receiving the protrusions, or vice versa.

According to an embodiment, the collar 100 further comprises a groove 101 on an outer perimeter of the collar 100 and a wedge 102 configured to be arranged in the groove 101, which wedge 102 is attached to the slip part 120. The groove can extend in the direction of the assembly axis. The groove can extend from the inner part 110 to the outer part 130. Thus, the collar 100 comprises the groove 101 on outer perimeters of the inner part 110 and the outer part 130. The wedge 102 can be attached to the slip part 120 by fastening means, such as screws, perpendicularly of the direction of the assembly axis. The wedge locks the inner part, slip part and outer part relative to each other so that the part cannot rotate relative to each other.

According to an embodiment, a drum 200 for use in forming, pressing or moulding a fibrous web comprises the collar 100.

According to an embodiment, the collar 100 of the drum 200 comprises the slip part 120 comprising a flange 121 extending perpendicularly to the assembly axis, which flange 121 has a first surface facing the drum 200 and an opposite second surface, which first surface is configured to engage a sleeve on the drum 200. The flange provides reliable attachment of the sleeve on the drum. The flange secures that the sleeve cannot protrude over the collar, but stays firmly attached on the drum.

According to an embodiment, the collar 100 of the drum 200 comprises several biasing mechanisms 140 arranged inside the collar 100 extending between the slip part 120 and the outer part 130 in a direction of the assembly axis, which several biasing mechanisms 140 are configured to adapt to a change in force on the slip part 120 caused by the deformation of the sleeve. So, the biasing mechanisms are able to conform and assist in the translation of the slip part. Further, the biasing mechanism assist in providing an even pressure along the entire circumference of the sleeve.

According to an embodiment, a nonwoven web machine comprises a collar 100 as described above. Thus, the collar can be part of the nonwoven web machine used in forming, pressing or moulding a fibrous web.

According to another embodiment, a method for installing a sleeve on a drum 200 comprises providing the sleeve on the drum, and attaching the collar 100 to an end of the drum 200 for creating an even pressure along the entire circumference of the sleeve. The method provides a reliable and cost-effective way to install the sleeve on a drum.

### DETAILED DESCRIPTION OF DRAWINGS

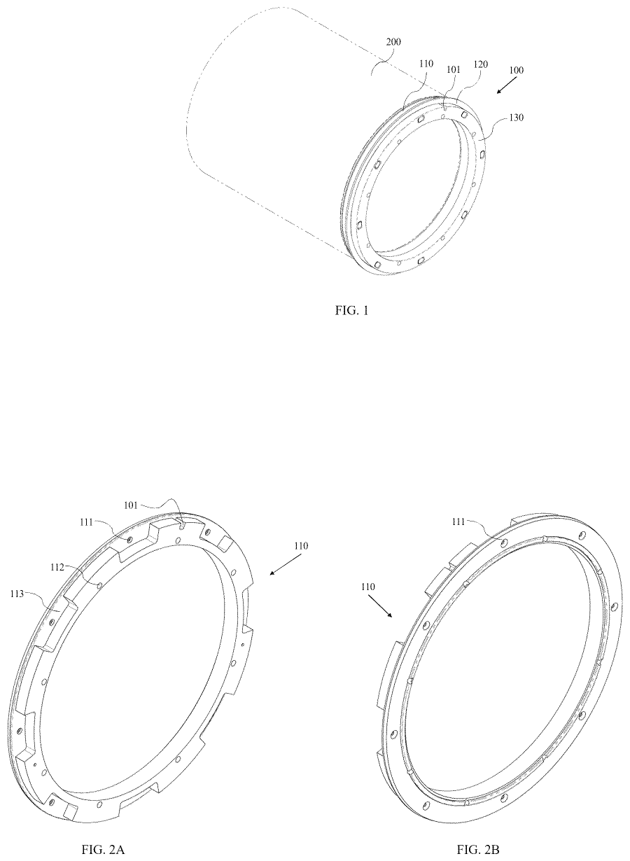

FIG. 1 illustrates a collar 100. The collar 100 comprises an inner part 110 configured to be attached to an end of the drum 200, an outer part 130, and a slip part 120 between the inner part 110 and the outer part 130. The inner part 110, the slip part 120 and the outer part 130 are assembled together in succession along an assembly axis. The collar 100 further comprises a groove 101 on an outer perimeter of the collar 100.

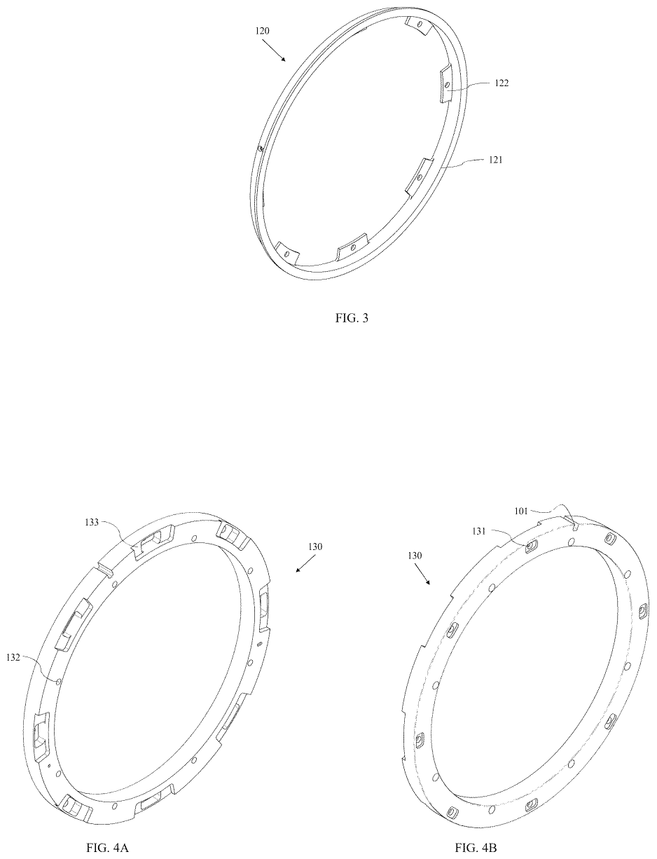

FIG. 2A illustrates an inner surface of an inner part 110. The inner part 110 comprises eight fastening apertures 111 for receiving a pivot for attaching the inner part 110 to an end of the pivot. In other words, the fastening apertures 111 are for securing the pivot and binding parts of the collar, i.e. the inner part, the slip part and the outer part, together. The fastening apertures 111 are arranged at regular intervals at the inner part 110. The inner part 110 further comprises eight attachment apertures 112 for receiving fastening means, such as bolts, for attaching the inner part 110 to an end of the drum. The fastening apertures 112 are arranged at regular intervals at the inner part 110. The inner part 110 further comprises eight mounting recesses 113 for receiving the mounting attachments of the slip part. The mounting recesses 113 are arranged at regular intervals at the inner part 110.

FIG. 2B illustrates an outer surface of an inner part 110. The inner part 110 comprises eight fastening apertures 111 for attaching the inner part 110 to an end of the pivot. The fastening apertures 111 are arranged at regular intervals at the inner part 110.

FIG. 3 illustrates a slip part 120. The slip part 120 comprises a flange 121 extending perpendicularly to the assembly axis. The slip part 120 further comprises eight mounting attachments 122 protruding towards a centre of the slip part 120 perpendicularly to the assembly axis. The mounting attachments are arranged at regular intervals at the slip part 120.

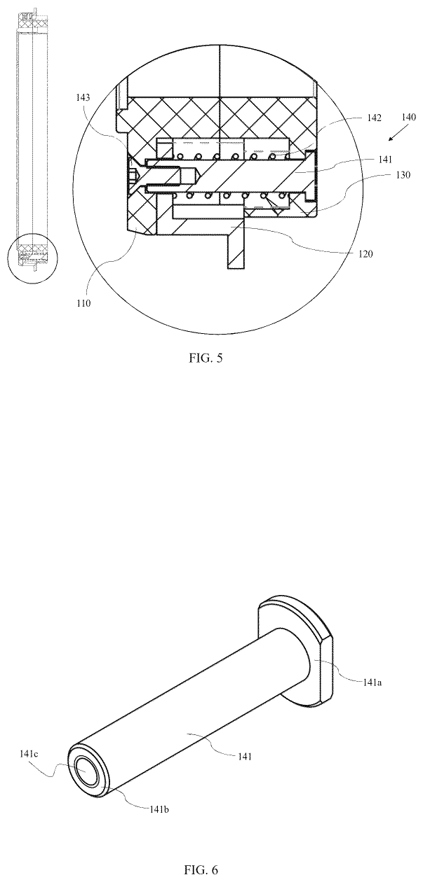

FIG. 4A illustrates an inner surface of an outer part 130. The outer part 130 comprises eight attachment apertures 132 for attaching the collar 100 to the end of the drum. The attachment apertures 132 are arranged at regular intervals at the outer part 110. The outer part 130 further comprises eight mounting recesses 133 for receiving the mounting attachments of the slip part. The mounting recesses 133 form with the mounting recesses 113 of FIG. 2A a sledge where the mounting attachments can translate between the inner part and the outer part along the assembly axis. The mounting recesses 133 are arranged at regular intervals at the outer part 130.

FIG. 4B illustrates an outer surface of an outer part 130. An outer surface of the outer part 130 comprises eight pivot recesses 131 for receiving heads of pivots.

FIG. 5 illustrates a biasing mechanism 140. The biasing mechanism 140 comprises a coil spring 142 between a slip part 120 and an outer part 130. A pivot 141 extends through the coil spring 142. A heads of the pivot 141a is arranged inside the outer part 130 so that a surface of the head is substantially at the same level than the outer surface of the outer part 130. An end of the pivot 141b has a recess. A screw 143 extends from an inner part 110 to inside of the recess for attaching the end of the pivot 141b to the inner part 110. A head of the screw 143 is substantially at the same level than the outer surface of the inner part 110.

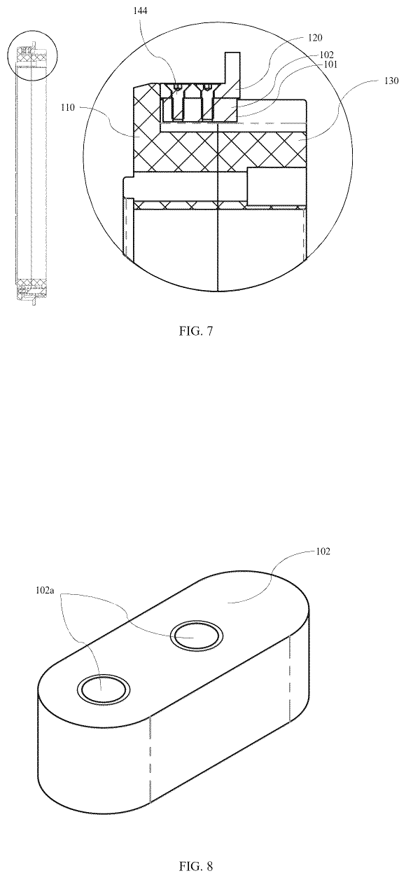

FIG. 6 illustrates a pivot 141. The pivot 141 has a head 141a and an end 141b. The end of the pivot comprises a recess 141c.

FIG. 7 illustrates a groove 101 on an outer perimeter of the collar 100 and a wedge 102 configured in the groove 101. The groove 101 extends from an inner part 110 to an outer part 130. The wedge 102 is attached to a slip part 120 by screws 144.

FIG. 8 illustrates a wedge 102 configured to be placed in the groove. The wedge 102 comprises two apertures 102a for receiving screws for attaching the wedge to a slip part.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

REFERENCE SIGNS LIST

| | |
|---|---|
| 100 | collar |
| 101 | groove |
| 102 | wedge |
| 110 | inner part |
| 111 | fastening aperture |
| 112 | attachment aperture |
| 113 | mounting recess |
| 120 | slip part |
| 121 | flange |
| 122 | mounting attachments |
| 130 | outer part |
| 131 | pivot recess |
| 132 | attachment aperture |
| 133 | mounting recess |
| 140 | biasing mechanism |
| 141 | pivot |
| 141a | head of pivot |
| 141b | end of pivot |
| 141c | recess |
| 142 | coil spring |
| 143 | screw |
| 144 | screw |
| 200 | drum |

1. A collar for compressing a sleeve on a drum, the collar comprising:
an inner part configured to be attached to an end of the drum,
an outer part, and
a slip part between the inner part and the outer part, which slip part is configured to be engaged with the sleeve,
wherein
the inner part, the slip part and the outer part are assembled together in succession along an assembly axis, and
the slip part is configured to translate between the inner part and the outer part along the assembly axis.

2. The collar of claim 1, wherein the slip part is configured to translate 20-40 mm, between the inner part and the outer part.

3. The collar of claim 1, wherein the slip part comprises a flange extending perpendicularly to the assembly axis.

4. The collar of claim 1, wherein the slip part comprises several mounting attachments protruding towards a centre of the slip part perpendicularly to the assembly axis.

5. The collar of claim 1, further comprising several biasing mechanisms arranged inside the collar extending between the slip part and the outer part in a direction of the assembly axis.

6. The collar of claim 5, wherein the several biasing mechanisms are configured to extend through the several mounting attachments.

7. The collar of claim 5, wherein the several biasing mechanisms comprise coil springs or leaf springs.

8. The collar of claim 7, wherein a pivot is configured to extend through the coil spring in a longitudinal direction of the coil spring.

9. The collar of claim 1, further comprising a plurality of pins extending from the inner part to the outer part to centre the inner part and the outer part relative to each other.

10. The collar of claim 1, further comprising a groove on an outer perimeter of the collar and a wedge configured in the groove, which wedge is attached to the slip part.

11. A drum for use in forming, pressing or moulding a fibrous web comprising the collar of claim 1.

12. The drum of claim 11, wherein the slip part comprises a flange extending perpendicularly to the assembly axis, which flange has a first surface facing the drum and an opposite second surface, and which first surface is configured to engage a sleeve on the drum.

13. The drum of claim 11, further comprising several biasing mechanisms arranged inside the collar extending between the slip part and the outer part in a direction of the assembly axis,
which several biasing mechanisms are configured adapt to a change in force on the slip part caused by the deformation of the sleeve.

14. A nonwoven web machine comprising the collar according to claim 1.

15. A method for installing a sleeve on a drum comprising:
providing the sleeve on the drum, and
attaching the collar of claim 1 to an end of the drum for creating even pressure along the entire circumference of the sleeve.
